(19) United States
(12) Patent Application Publication
(10) Pub. No.: US 2015/0306616 A1
(43) Pub. Date: Oct. 29, 2015

(54) Spray Bottle And Refill Pack Assembly

(71) Applicant: Scholle Corporation, Irvine, CA (US)

(72) Inventor: Peter Messacar, Elmhurst, IL (US)

(21) Appl. No.: 14/697,305

(22) Filed: Apr. 27, 2015

Related U.S. Application Data
(60) Provisional application No. 61/984,758, filed on Apr. 26, 2014.

(51) Int. Cl. B05B 11/00; B65D 25/04; B65D 25/54; B65D 25/28; B65B 3/04; B65D 77/06

(52) U.S. Cl. CPC B05B 11/0037; B05B 11/3047; B65B 3/04; B65D 77/06; B65D 25/54; B65D 25/28; B65D 25/04

(57) ABSTRACT

A bottle and refill pack assembly comprising an outer carton, a bag assembly and a bottle. The outer carton defines a cavity. The cavity includes a separator member which divides the cavity into a first chamber and a second chamber. The bag assembly is positioned within the first chamber. The bag assembly has a spout and a dispenser. At least one of the spout and dispenser is extendable through an opening in the outer carton to allow the dispenser to be actuatable outside of the cavity. The bottle is positioned within the second chamber. The bottle may comprise a spray bottle.

### CROSS-REFERENCE TO RELATED APPLICATION

This application claims priority from U.S. Provisional Patent Application Ser. No. 61/984,758, filed Apr. 26, 2014, entitled “Spray Bottle And Refill Pack Assembly,” the specification of which is hereby incorporated by reference in its entirety.

### BACKGROUND OF THE DISCLOSURE

1. Field of the Disclosure

The invention relates in general to bag in box packaging, and more particularly, to a bottle and refill pack assembly wherein the bottle is provided in an outer carton which also includes a refill pack that comprises a flexible bag with a spout thereon and a dispenser (i.e., tap) coupled thereto. The bottle may be supplied with a spray dispensing mechanism (such as a trigger operated spray bottle or the like). The disclosure, however, is not limited thereto.

2. Background Art

The use of spray bottles is well known in the art (as well as bottles, for example, with dispensers and the like). Generally, the spray bottles are filled with a fluid such as a cleaner, a polish, a lubricant and the like. The trigger can be activated to spray a stream of the fluid. Recently it has been increasingly popular to sell a refill container which is substantially larger along with the spray bottle. Thus, when the fluid is emptied from the spray bottle, it can be refilled from the refill container. Problematically, such refill containers cause many spilling problems. It is often difficult to dispense the refill fluid from a container which has a larger opening to the smaller opening of the spray bottle. In addition, as both are rigid containers, it is often difficult to manage both of the containers. These problems, among others have limited the market acceptance of the refill packs.

On the other hand, by providing such refill containers, the use of raw materials can be minimized, as the spray bottle, when emptied, is typically fully functional.

### SUMMARY OF THE DISCLOSURE

The disclosure is directed to a bottle and refill pack assembly. The bottle and refill pack assembly further comprising a bottle and a refill pack assembly. The bottle comprising a body defining a cavity. The bottle having an opening at an end thereof. Additionally, a removable member sealing the opening. It will be understood that the removable member may comprise a spray mechanism, a cover, a drip type mechanism, allowing for a stream or a drip therefrom, or another type of dispensing or non-dispensing member.

The refill pack assembly has a bag and an outer rigid container. The bag has at least one panel with at least one seal, defining a substantially fluid tight cavity. with a dispenser associated with the at least one panel providing access to the cavity, toward the selective dispensing therefrom. The outer rigid container includes a plurality of walls to define a container cavity. The container cavity has a first chamber and a second chamber. The first chamber is separated from the second chamber by the separator member;

The bag is positioned within the first chamber of the outer rigid container, and the bottle is removably positioned within the second chamber of the outer rigid container. The first chamber has an opening configured to retain at least one of the spout and the dispenser to facilitate the dispensing of a fluid from within the bag to the bottle.

In some configurations, the outer rigid container further includes at least one window portion extending about at least one of the plurality of walls corresponding to the second chamber.

In some configurations, the at least one window portion includes at least one window portion on at least two of the plurality of walls corresponding to the second chamber.

In some configurations, the at least one window portion includes at least one window portion on at least two of the plurality of walls in a continuous configuration.

In some configurations, at least a portion of the body of the bottle is visible through the window portion.

In some configurations, a clear film is disposed over the window portion, to, in turn, at least partially cover the same.

In some configurations, the opening in the outer rigid container is on a wall opposite from the separator member.

In some configurations, the outer rigid container comprises a rectangular cubic configuration including a bottom wall, a top wall opposite the bottom wall, a first side wall and a second side wall opposite the first side wall, and a front wall and back wall opposite the front wall. The separator member extends between the first side wall and the second sidewall spaced apart from each of the front wall and the back wall.

In some configurations, the separator member is substantially parallel to each of the front wall and back wall, thereby defining the first chamber and the second chamber.

In some configurations, the separator member is positioned closer to the back wall than the front wall, to in turn, render the first chamber larger than the second chamber.

In some configurations, the bottle is positioned in an upright configuration within the second chamber, with a base thereof positioned on the bottom wall.

In some such configurations, the removable member comprises a spray mechanism coupled to the opening, the spray mechanism structurally configured to withdraw and dispense fluid from within the cavity of the bottle.

In some such configurations, the outer container further includes a reclosable portion corresponding to the second chamber, to selectively allow access to the second chamber, independent of the first chamber. Such a configuration allows for the storage and access to the bottle selectively.

In some configurations, the top wall further includes at least one handle structure structurally configured to facilitate grasping and handling thereof.

In some configurations, access to the first chamber is permitted solely to the opening configured to retain at least one of the spout and the dispenser.

In another aspect of the disclosure, the disclosure is directed to a method of dispensing a flowable material comprising the steps of: providing a refill pack assembly including an outer rigid container and a bag having a flowable material positioned therein, the bag having a dispenser configured to dispense flowable material therefrom, the outer rigid container including a first chamber and a second chamber, with the bag positioned within the first chamber, the outer rigid container further including an opening providing ingress into the first chamber; providing a bottle having a body within the second chamber; directing the dispenser through the opening in the outer rigid container, to in turn, direct at least a portion outside of the first camber; removing the bottle from the second chamber; filling the bottle with a flowable material from the bag through the dispenser outside of the first chamber; and dispensing the flowable material from within the bottle.

In some configurations, the method further comprises the steps of: refilling the bottle with the flowable material from the bag through the dispenser outside of the first chamber after the step of dispensing the flowable material from within the bottle.

In some configurations, the method further includes the step of: storing the bottle within the second chamber after the step of removing the bottle from the second chamber.

In some configurations, the outer rigid container further includes a window portion providing visual access to the second chamber. The method further includes the step of: inspecting the bottle through the window portion.

In some configurations, the bottle includes a body and a spray mechanism separately positioned therefrom. In some such configurations, the method further includes the step of: coupling the body to the spray mechanism.

### BRIEF DESCRIPTION OF THE DRAWINGS

The disclosure will now be described with reference to the drawings wherein:

FIG. 1 of the drawings is a perspective view of the spray bottle and refill pack assembly of the present disclosure;

FIG. 2 of the drawings is a side elevational view of an exemplary spray bottle for use in association with the spray bottle and refill pack assembly of the present disclosure;

FIG. 3 of the drawings is a top plan view of an exemplary bag for use in association with the spray bottle and refill pack assembly of the present disclosure;

FIG. 4 of the drawings is a cross-sectional view of the exemplary bag taken generally about lines 4-4 of FIG. 3;

FIG. 5 of the drawings is a top plan view of the outer carton with the top wall removed; and

FIG. 6 of the drawings is a partial perspective view of the bag having the spout and an exemplary dispenser/tap coupled thereto with the understanding that the disclosure is not limited to such a tap; and

FIG. 7 of the drawings is a top plan view of the outer carton with the top wall removed and the configuration of the spout/dispenser being positioned through the opening in the separator member, and with the bottle being positioned in the second chamber, which is removable (may be perforated or the like), allowing for removal of the second chamber altogether from the container, thereby exposing the tap/dispenser.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

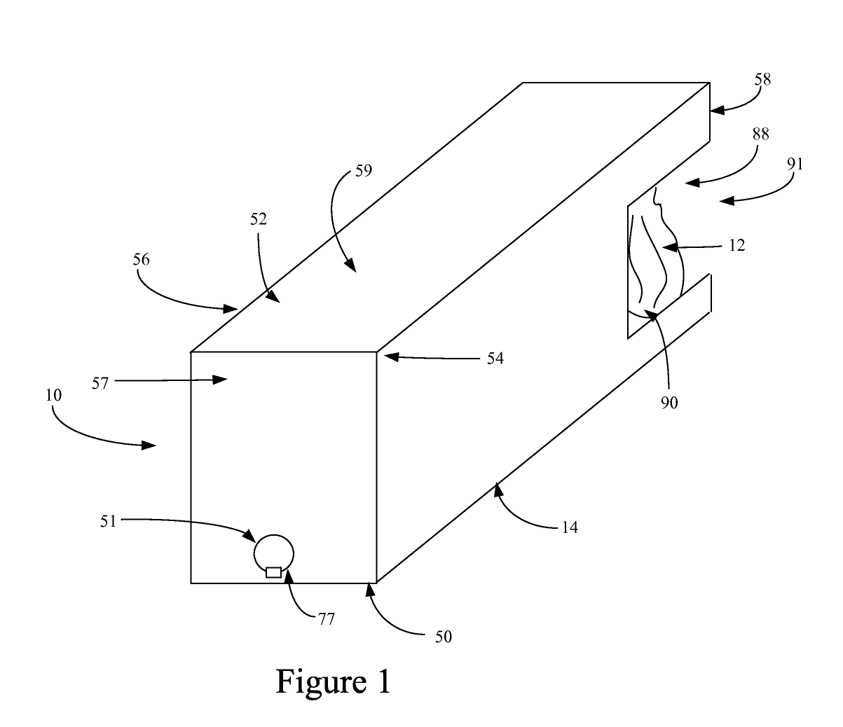

Referring now to the drawings and in particular to FIG. 1, the disclosure is directed to a bottle and refill pack assembly 10. The assembly comprises a bottle, such as, for example, spray bottle 12 and refill pack assembly 14, which also provides a housing for the bottle 12. It will be understood that the particular type of flowable material that is contained within the spray bottle and the desired use of the spray bottle is generally not limiting. It will also be understood that particular reference may be made to a spray bottle which includes a cleaning fluid that can be applied therefrom, such disclosure is meant to be exemplary only, and is not intended to be limiting.

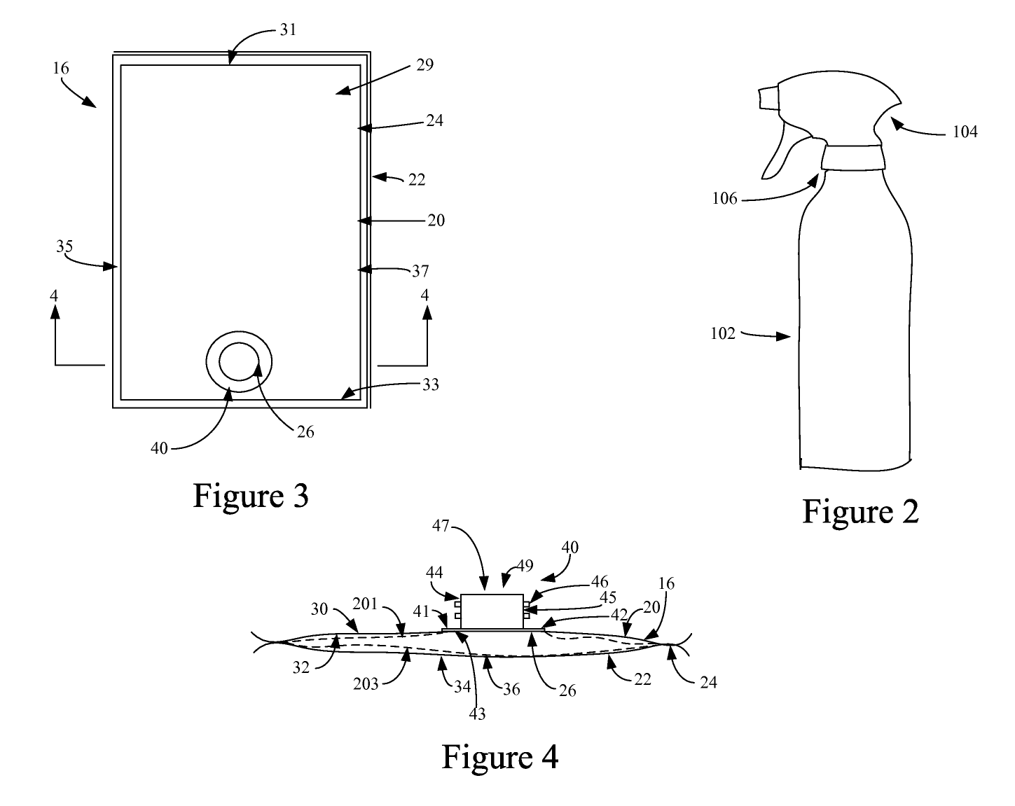

With reference to FIG. 2, the spray bottle includes a body 102 and spray mechanism 104. The body 102 includes a neck with an opening 106 that provides ingress into the cavity of the body 102. The neck includes a coupling mechanism, such as a thread disposed thereon (other snap type coupling mechanisms are likewise contemplated. The spray mechanism typically includes a coupling mechanism which allows for releasable engagement with the coupling mechanism of the body 102. A mechanism for drawing fluid from within the body and through an opening in the spray mechanism is likewise provided. Often, the system relies upon a pumping of fluid from within the body and forcing of the fluid through an opening on the spray mechanism. The pumping action is often achieved through the actuation of a trigger. Such spray bottles are well known in the art. One type of cleaner, for example, that employs such a spray bottle is a cleaner sold under the brand Formula 409. It will be understood that such a spray bottle is merely disclosed for purposes of illustration and example. Any number of other spray bottles of the type that are suitable for use in association with the present disclosure are known in the art. Such spray bottles may be utilized with cleaners, polishing fluids, lubricating fluids, among others, without limitation.

It is further contemplated that while reference is made to a spray bottle, a bottle that has an applicator other than a spray applicator (i.e., a drip dispenser, a valve member actuated by pressure from within the body of the spray bottle are likewise contemplated). In some configurations, the body of the spray bottle may be supplied with a cap, and a separate spray mechanism, or without any spray mechanism at all. The cap can be removed and the spray mechanism or other type of dispenser may be positioned in its place. The preferred embodiment is shown with a spray bottle, with the understanding that other bottles are contemplated, and with the understanding that the application is not limited thereto.

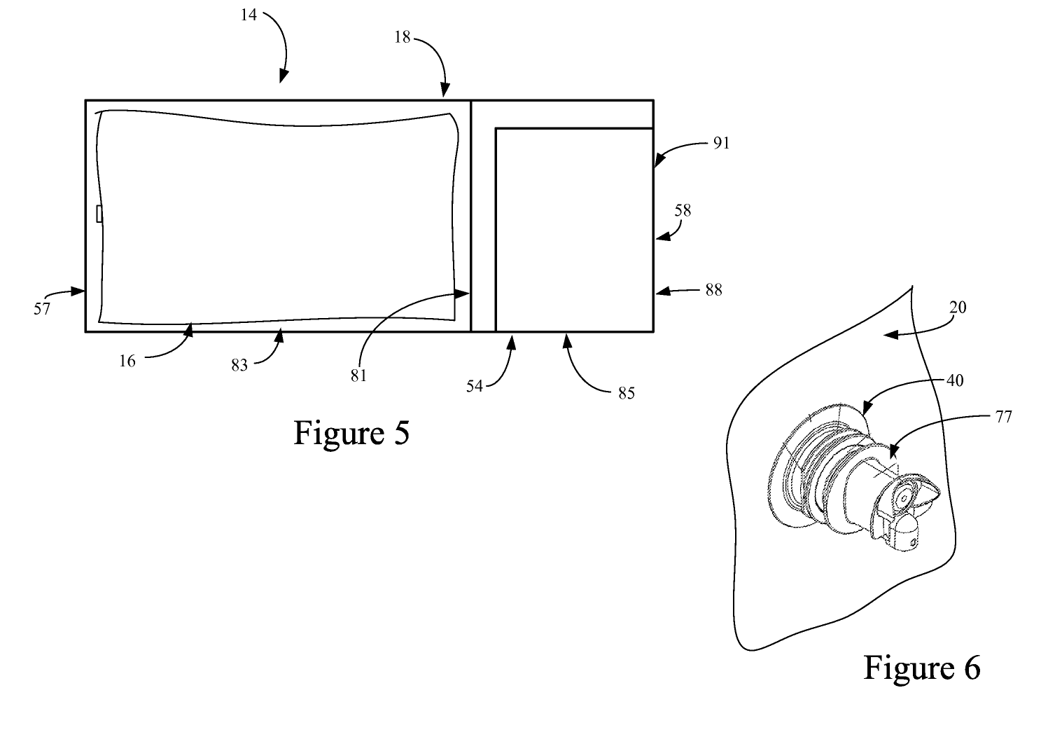

The refill pack assembly 14 is shown in FIG. 5 as comprising a bag 16 and an outer carton 18. The bag may comprise any number of different bags, among which, are included pillow type bags. Such a bag includes front panel 20 and back panel 22. Front panel 20 includes outer surface 30 and inner surface 32. The back panel 22 includes outer surface 34 and inner surface 36. The front and back panel are positioned in an overlying orientation so that the inner surfaces face each other.

The panels are then coupled together by way of seals 24. In the case of a pillow type container, the seals 24 include a top seal 31, bottom seal 33, first side seal 35 and second side seal 37. The seals are generally perpendicular to adjacent seals and parallel to opposing seals to generally define a square or rectangular configuration, thereby defining a generally square or rectangular cavity 29. The seals may be formed through the application of heat, or through other procedures, including, but not limited to RF welding, ultrasonic welding, adhesive, among others. The disclosure is not limited to any particular manner of attachment of the panels.

For many pillow type containers, an opening 26 is provided through the front panel 20 proximate, but spaced apart from the bottom seal 33. A spout 40 can be coupled thereto in sealed engagement. In certain embodiments, multiple spouts may be provided, one, for example, for dispensing, and one for filling. In other embodiments, spouts may be positioned along the seals so as to extend between the panels. The film is configured for use in association with multiple configurations of spouts, as well as in embodiments that do not require spouts.

It will be understood that while a pillow type bag is shown, the film is not limited to use therewith. For example, the bay may comprise a gusseted bag wherein four panels are coupled together to form a generally rectangular shaped bag. One such configuration is shown in U.S. Pat. No. 5,788,121 issued to Sasaki et al. Another such configuration is shown in U.S. Pat. No. 6,783,277 issued to Edwards. The foregoing patents are incorporated by reference in their entirety.

It will further be understood that a single ply pillow type bag is shown in FIG. 1 (with optional dashes shown in FIG. 4 for an additional inner ply 201, 203), while other configurations are contemplated. For example, a multi-ply bag, pillow, or otherwise, is likewise contemplated for use. For example, such a container may include multiple plies, sharing common seals, or having separate individual seals. It will be understood that each ply may comprise a different wall construction, and it is contemplated that the multiple plies may comprise co-extrusions, laminates or a combination of the structures. For example, as set forth below, a two ply configuration was utilized for testing purposes, with the outer ply comprising the film of the present disclosure.

One type of spout is shown in FIG. 4 as comprising a base flange 42, and upstanding wall 44 extending from the base flange. The base flange includes top surface 41 and bottom surface 43 opposite top surface 41. Generally the base flange is substantially planar and generally perpendicular to the upstanding wall 44. Either one of the top and bottom surfaces may be sealed to the front panel about opening 26, through a heat seal. Of course, other sealing methods, such as those identified above may be utilized in place of heat sealing.

The upstanding wall includes an outer surface 45 which includes grasping flanges, such as grasping flange 46 extending about the outer surface. Generally, these grasping flanges are disposed in a spaced apart orientation along the outer surface, generally parallel to the base flange 42. Of course, other configurations are likewise contemplated. The upstanding wall defines a passageway, which is generally of a circular configuration, terminating at opening 49 spaced distally from the base flange 42. Of course, other cross-sectional configurations are contemplated, and the disclosure is not limited to any particular configuration of the spout.

With reference to FIG. 6, it will be understood that any number of different dispensers, such as dispenser tap 77, may be coupled to the spout described above. For example, a cap or a dispensing fitment may be coupled to the above configuration. It is contemplated, for example, that dispensers such as those disclosed in U.S. Pat. Nos. 4,619,377 and 6,978,981 both of which are issued to Roos as well as U.S. Pat. Nos. 6,045,119; 6,296,157 and 6,360,925 issued to Erb, U.S. Pat. No. 8,336,743 issued to Bellmore, and U.S. Pat. No. 7,240,811 issued to Roser could be utilized. Each of the foregoing references are incorporated by reference in their entirety. Additionally, it will be understood that the spout or the cavity may further include different structures to aid in the dispensing of flowable material. Preferably, such structures allow for the selective dispensing of fluid from within the bag.

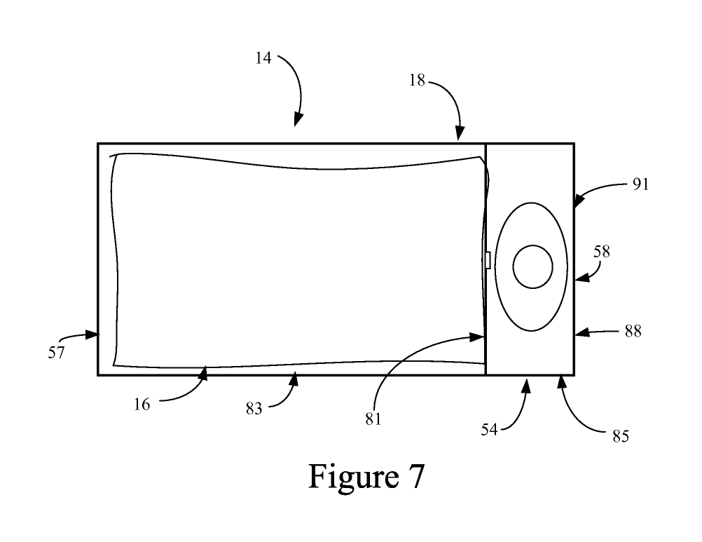

It will be understood that such a bag may be positioned within a rigid outer carton 18 which is shown in FIG. 5. With additional reference to FIG. 1, the outer carton, typically includes a bottom wall 50, top wall 52, first side wall 54, second side wall 56, front wall 57 and back wall 58. The outer box that is shown in the Figures comprises a rectangular cubic configuration. Of course, such a configuration is merely exemplary, and not to be deemed limiting. It will be understood that other containers, such as those having fewer or greater number of sides (i.e., a hexagonal or octagonal box having a plurality of sides along with a bottom and top wall are contemplated as well). In some embodiments, one of the walls, and in the embodiment shown, the front wall 57, may include an opening 51 which provides access to the cavity 59, and the bag therein. In other embodiments, it may be necessary to remove one of the walls to gain access to cavity 59. One such example is shown in FIG. 7, wherein the back wall 58, along with portions of the bottom and top walls, and the first and second side walls are removed (i.e., most or all of the second chamber, with the opening configured to retain the spout/dispenser being positioned on the separator member 81. In such a configuration, the spout/dispenser can already be coupled to the opening in the separator member, or the user may need to pull the same through the opening and manually assemble the same. It is contemplated that the outer carton comprises a paperboard material, such as a corrugated paperboard. Of course, other materials are likewise contemplated for use, including, but not limited to, other paperboard materials, polymer materials, including bio-polymers, and the like.

With reference to FIG. 5, the outer container cavity 59 includes separator member 81 which extends across between the side wall 54 and the sidewall 56 spaced apart from the front wall 57 and the back wall 58. Such a configuration forms a first chamber 83 on the one side of the separator member and a second chamber 85 on the other side of the separator member. As will be explained below, the bag is positioned within the first chamber 83 while the spray bottle is positioned in the second chamber 85. An opening may be provided on the front wall to releasably retain the spout and/or the dispenser.

A continuous window opening 88 may be defined into the sidewall 54 and the back wall 58 which includes side window portion 90 and back window portion 91. It will be understood that the opening may be formed from two cuts that extend across the two panels, and then the portion between the cuts can be pushed inwardly to create a fold at the side wall and the back wall. In such a configuration, the portion of the walls that has been pushed in, can provide a capture member for the spray bottle.

As set forth above, in some configurations, the second chamber 85 may be fully removed (i.e., separated from the first chamber). In such a configuration, upon separation, the separator member 81 becomes the back wall. In some such embodiments, the spout/dispenser is exposed upon such removal, whereas in other configurations, the spout/dispenser is withdrawn from the first chamber through an opening therein. It will be understood that in certain configurations, the outer rigid container may be formed from a single blank, such that the first chamber and the second chamber are formed from the same panels, with a separator member being positioned within the cavity. In other configurations, however, the first chamber may be formed from a first container, whereas the second chamber may be formed from a second container. In such a configuration, the separator member may be an integral part of the first container or the second container.

In operation, it is contemplated that the refill pack assembly is assembled. In particular, the outer carton can be provided from a blank and formed into the desired configuration. Next, the bag can be filled with the desired fluid and a suitable dispenser can be provided and coupled to the spout of the bag. Finally, the bag can be dropped into the first chamber 83 of the cavity defined by the outer carton. The bag can be turned in such a way that the spout/dispenser can easily be grasped by the user through the opening in the front wall and coupled thereto in a dispensing configuration.

Once the bag is properly positioned, the spray bottle can be placed into the second chamber in a position to be visible through the window 88. Once positioned, the top of the outer carton can be closed, and the pack is complete. The procedure is slightly different wherein the two chambers are formed by separate containers, in that the separate container portions are first joined together to form the outer rigid container.

The end user can take the package and remove the spray bottle from within the second chamber. The window can be configured to allow the user to remove the spray bottle from the second chamber through the window. In other embodiments, the top can be opened (at least partially) to allow for the removal of the spray bottle. In still other embodiments, a portion of the outer carton that corresponds to the second chamber can be ripped or otherwise removed to allow for the removal of the spray bottle.

The user is then able to use the spray bottle. When the spray bottle has been emptied, the user can refill the spray bottle from the flexible bag. In particular, the user can couple the spout to the front wall of the outer carton (to the extent that it was not previously coupled). Next, the user can remove the spray mechanism from the spray bottle and place the opening in communication with the outlet of the bag dispenser. Once opened, the fluid from the bag will proceed into the bottle. The user can stop the flow from the dispenser and reposition the spray mechanism, as the dispenser is configured properly to minimize spilling. It is contemplated that once the user is done utilizing the spray bottle, the spray bottle can be reinserted into the second chamber, or may be stored elsewhere (especially if the second chamber has been decoupled from the first chamber.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A bottle and refill pack assembly comprising:
a bottle comprising:
a body defining a cavity, the bottle having an opening at an end thereof; and
a removable member sealing the opening; and
a refill pack assembly comprising:
a bag having at least one panel with at least one seal, defining a substantially fluid tight cavity, with a dispenser associated with the at least one panel providing access to the cavity, toward the selective dispensing therefrom;
an outer rigid container including a plurality of walls to define a container cavity, the container cavity having a first chamber and a second chamber, the first chamber separated from the second chamber by the separator member;
wherein the bag is positioned within the first chamber of the outer rigid container, and the bottle is removably positioned within the second chamber of the outer rigid container, the first chamber having an opening configured to retain at least one of the spout and the dispenser to facilitate the dispensing of a fluid from within the bag to the bottle.

2. The bottle and refill pack assembly of claim 1 wherein the outer rigid container further includes at least one window portion extending about at least one of the plurality of walls corresponding to the second chamber.

3. The bottle and refill pack assembly of claim 2 wherein the at least one window portion includes at least one window portion on at least two of the plurality of walls corresponding to the second chamber.

4. The bottle and refill pack assembly of claim 3 wherein the at least one window portion includes at least one window portion on at least two of the plurality of walls in a continuous configuration.

5. The bottle and refill pack assembly of claim 3 wherein at least a portion of the body of the bottle is visible through the window portion.

6. The bottle and refill pack assembly of claim 5 wherein a clear film is disposed over the window portion, to, in turn, at least partially cover the same.

7. The bottle and refill pack assembly of claim 1 wherein the opening in the outer rigid container is on a wall opposite from the separator member.

8. The bottle and refill pack assembly of claim 1 wherein the outer rigid container comprises a rectangular cubic configuration including a bottom wall, a top wall opposite the bottom wall, a first side wall and a second side wall opposite the first side wall, and a front wall and back wall opposite the front wall, the separator member extending between the first side wall and the second sidewall spaced apart from each of the front wall and the back wall.

9. The bottle and refill pack assembly of claim 8 wherein the separator member is substantially parallel to each of the front wall and back wall, thereby defining the first chamber and the second chamber.

10. The bottle and refill pack assembly of claim 9 wherein the separator member is positioned closer to the back wall than the front wall, to in turn, render the first chamber larger than the second chamber.

11. The bottle and refill pack assembly of claim 8 wherein the bottle is positioned in an upright configuration within the second chamber, with a base thereof positioned on the bottom wall.

12. The spray bottle and refill pack assembly of claim 1 wherein the removable member comprises a spray mechanism coupled to the opening, the spray mechanism structurally configured to withdraw and dispense fluid from within the cavity of the bottle.

13. The bottle and refill pack assembly of claim 12 wherein the outer container further includes a reclosable portion corresponding to the second chamber, to selectively allow access to the second chamber, independent of the first chamber, to, in turn, allow for the storage and access to the bottle selectively.

14. The bottle and refill pack assembly of claim 8 wherein the top wall further includes at least one handle structure structurally configured to facilitate grasping and handling thereof.

15. The bottle and refill pack assembly of claim 13 wherein access to the first chamber is permitted solely to the opening configured to retain at least one of the spout and the dispenser.

16. A method of dispensing a flowable material comprising the steps of:
providing a refill pack assembly including an outer rigid container and a bag having a flowable material positioned therein, the bag having a dispenser configured to dispense flowable material therefrom, the outer rigid container including a first chamber and a second chamber, with the bag positioned within the first chamber, the outer rigid container further including an opening providing ingress into the first chamber;
providing a bottle having a body within the second chamber;
directing the dispenser through the opening in the outer rigid container, to in turn, direct at least a portion outside of the first camber;
removing the bottle from the second chamber;
filling the bottle with a flowable material from the bag through the dispenser outside of the first chamber; and
dispensing the flowable material from within the bottle.

17. The method of claim 16 further comprising the steps of:
refilling the bottle with the flowable material from the bag through the dispenser outside of the first chamber after the step of dispensing the flowable material from within the bottle.

18. The method of claim 16 further comprising the step of:
storing the bottle within the second chamber after the step of removing the bottle from the second chamber.

19. The method of claim 16 wherein the outer rigid container further includes a window portion providing visual access to the second chamber, the method further including the step of:
inspecting the bottle through the window portion.

20. The method of claim 19 wherein the bottle includes a body and a spray mechanism separately positioned therefrom, the method further includes the step of:
coupling the body to the spray mechanism.
